(19) United States
(12) Patent Application Publication
(10) Pub. No.: US 2013/0230929 A1
(43) Pub. Date: Sep. 5, 2013

(54) AGENT FOR DETECTING HALIDE, METHOD FOR DETECTING HALIDE, AND DETECTION SENSOR

(71) Applicants: Tooru Nakamura, Tsukuba-shi (JP); Yukihiro Shimoi, Tsukuba-shi (JP)

(72) Inventors: Tooru Nakamura, Tsukuba-shi (JP); Yukihiro Shimoi, Tsukuba-shi (JP)

(73) Assignee: NATIONAL INSTITUTE OF ADVANCED INDUSTRIAL SCIENCE AND TECHNOLOGY, tokyo (JP)

(21) Appl. No.: 13/807,583

(22) PCT Filed: Jun. 23, 2011
(86) PCT No.: PCT/JP2011/064346

§ 371 Date: May 10, 2013

(30) Foreign Application Priority Data
Jun. 29, 2010 (JP) 2010-147782
Oct. 29, 2010 (JP) 2010-242895
Jun. 10, 2011 (JP) 2011-129703

(51) Int. Cl. G01N 21/64

(52) U.S. Cl. CPC G01N 21/643
USPC 436/126; 540/579; 422/83; 544/282

(57) ABSTRACT

[Problems to be solved by the invention]

A method and sensor for detecting the fluorides, chlorides or bromides of hydrocarbons such as C₅F₈ or C₄F₆ are provided, which are capable of the detection with quickness and high sensitivity at a room temperature or a temperature closer thereto, not a high temperature, without interference with hindrance gases from fluorine liquids or the like.

[Means for solving the problems]

A detection agent, detection method, and detection sensor based on an optical change or mass change by a direct reaction with a nitrogen compound having at least two rings at which an amidine backbone is centered, which is represented by the following general formula (I).

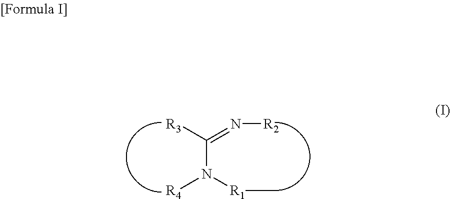

### FIELD OF THE INVENTION

The present invention relates to a detection agent for a halide, a detection method and sensor for detecting a halide, particularly, a halide which is selected from fluorides of unsaturated hydrocarbons having at least a hydrogen-carbon moiety in a molecule and having an anionic elimination group bonded to a carbon next to a carbon bonded to the hydrogen-carbon moiety, unsaturated hydrocarbons having only chlorine and/or bromine as a substituent group, and saturated hydrocarbons having two or more carbons which have only chlorine and/or bromine as a substituent group.

### BACKGROUND OF ART

It has been desired to reduce usage of a fluorine containing compound as it is a cause of global warming since discussions for the Kyoto Protocol Treaty. There are needs for trace detection, decomposition, reduction of used amounts, and a recovery technique for the fluorine containing compound to save global environment and a variety of organism species and human races.

In particular, usage of saturated fluorocarbons such as carbon tetrafluorides and octafluorocyclobutane used as a dry etching gas is restricted because they may cause global warming. As substitutes for these compounds, fluorohydrocarbon compounds having an unsaturated carbon bond in a molecule such as octafluorocyclopentene (C₅F₈), hexafluorobutadiene (C₄F₆) and hexafluorocyclobutene (C₄F₆) have been developed. These fluorohydrocarbons having the unsaturated carbon bond (hereinafter, “the fluorides of unsaturated hydrocarbons”) have been known as high performance materials for a high selected ratio in a microfabrication process, and some of those are used in each semiconductor process. Although these compounds have an improved global warming potential, they are subject to 2 ppm of concentration restriction as a management standard due to their high vapor pressure and toxicity. Further, in view of the environmental burden by these compounds, there are needs for high sensitive detection techniques as they can be gas contamination sources in the processing location environment.

As the detection method for the fluorides of unsaturated hydrocarbons, a method using permanganate or pyrolysis have been developed to date. The method using permanganate utilizes color disappearance of the permanganate by a reaction of C₅F₈ or C₄F₆ with the permanganate (Patent publication 1). However, the method has the following demerits.

(1) The reaction is so slow that the detectable concentration is high such as 50 ppm or more. (2) The detection time is long as it takes 19 minutes or more on average at 50 ppm. (3) Because of the use of inorganic substance, there is the difficulty in workability, and manners of the detection are limited. (4) Because of the use of permanganate which is strong oxidant, this may cause erroneous detection due to erroneous color disappearance by reacting agents such as hydrides or complex compounds of boron derivatives or the like.

The method using pyrolysis utilizes pyrolysis of C₅F₈ or C₄F₆ existing in the air in a pyrolytic furnace, and quickly, optically detects an acidic gas generated by the pyrolysis (Patent publication 2). However, this method has the following demerits.

(1) Since it uses the pyrolysis, it consumes a lot of energy. (2) Since the pyrolysis is performed at a high temperature, erroneous detection may occur due to similar gases resulting from acidic gases from fluorine liquids often used for cleaning agents and insulating materials. (3) Because of the high reaction temperature, it generates highly dangerous acidic gas HF. (4) Finally, because of the detection of the highly dangerous gas, erroneous detection may occur when there is contamination with other similar acidic gases themselves.

### PRIOR ART REFERENCES

Patent publication 1: JP2001-324492, and
Patent publication 2: JP2001-324491.

### SUMMARY OF THE INVENTION

### Problems to be Solved by the Invention

As discussed above, there are the problems in the conventional detection methods for the fluorides of unsaturated hydrocarbons, and therefore, there are needs for a novel, high-performance and economic method which is totally different from the conventional methods. In view of the circumstances discussed above regarding conventional art, the object of the present invention is to provide a method for detecting the fluorides of hydrocarbons such as C₅F₈ or C₄F₆, which allows is capable of simpler and quicker detection at a room temperature or a temperature closer thereto without using the high temperature pyrolysis or strong oxidant, and without interference with hindrance gases from fluorine liquids or the like, and with the quickness and high sensitivity.

### Means for Solving the Problems

From the study to solve the problems mentioned above, the present inventors have arrived at the utilization of selective and direct organic reactions of the fluorides of unsaturated hydrocarbons such as C₅F₈ or C₄F₆. That is, as a result of the study on the selective and direct organic reactions of the fluorides of unsaturated hydrocarbons such as C₅F₈ or C₄F₆, the inventors have found a selective and high-sensitive unique coloring reaction when using specific nitrogen compounds, which makes it possible to selectively detect the fluorides of unsaturated hydrocarbons that is detection targets. Further, it has been found that the reaction provides small-amount detection a mass change with the reaction. Furthermore, it has been found that it becomes possible to detect gaseous fluorides of unsaturated hydrocarbons having at least a hydrogen-carbon moiety in a molecule and having an anionic elimination group bonded to a carbon next to a carbon bonded to the hydrogen-carbon moiety, and to detect chlorides and/or bromides having only choline and/or bromine as a substituent group.

The present invention has been completed based on the above concepts. The present invention provides the following aspects.

[1] A detection agent which detects a halide of any one kind selected from (1) the fluorides of unsaturated hydrocarbons, (2) the fluorides of hydrocarbons having at least a hydrogen-carbon moiety in a molecule and having an anionic elimination group bonded to a carbon next to a carbon bonded to the hydrogen-carbon moiety, (3) unsaturated hydrocarbons having only choline and/or bromine as a substituent group, and (4) saturated hydrocarbons having two or more carbons which have only chlorine and/or bromine as a substituent group, in which the detection agent has as a main component a nitrogen compound having at least two rings at which an amidine backbone is centered, which is represented by the following general formula (I).

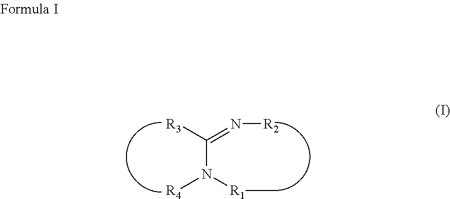

[in the formula, each of R₁, R₂, R₃ and R₄ represents a methylene group (CH₂) which may be substituted with other hetero atoms, or a hetero atom of a nitrogen atom (N), an oxygen atom (O) or an sulfur atom (S) which may have a substituent group; a hydrocarbon group or a substituent group formed of a polymer having such hydrocarbon group may be present or introduced between R₃ and R₄ in the compound; and such groups may form additional ring portions, thereby forming three or more of rings as the compound.]

[2] A detection agent according to the above [1], characterized in that the fluorides of unsaturated hydrocarbons described in above (1), or the fluorides of hydrocarbons described in above (2) which has at least a hydrogen-carbon moiety in a molecule and has an anionic elimination group bonded to a carbon next to a carbon bonded to the hydrogen-carbon moiety are in a gas form.

[3] A detection agent according to above [1] or [2], characterized in that a nitrogen compound having at least two rings at which an amidine backbone is centered and which is represented by the following general formula (I) is 1,5-diazabicyclo[4,3,0]non-5-ene (DBN) and/or derivatives thereof.

[4] A detection agent according to above [1] or [2], characterized in that a nitrogen compound having at least two rings at which an amidine backbone is centered and which is represented by the following general formula (I) is 1,8-diazabicyclo[5,4,0]non-7-ene (DBU) and/or derivatives thereof.

[5] A detection agent according to above [1] or [2], characterized in that a nitrogen compound having at least two rings at which an amidine backbone is centered and which is represented by the following general formula (I) is 1,3,4,6,7,8-hexahydro-2H-primido[1,2-a]pyrimidine (HPP) (another name thereof is 1,5,7-triazabicyclo[4,4,0]dec-5-en) and/or derivatives thereof.

[6] A detection agent according to above [1] or [2], characterized in that a nitrogen compound having at least two rings at which an amidine backbone is centered and which is represented by the following general formula (I) is tetramisole (another name thereof is Levamisole).

[7] A method of detecting fluorides using a detection according to claims 1-6, characterized in that the method detects the fluorides by using a reaction of the detection agent with a halide of any one selected from (1) the fluorides of unsaturated hydrocarbons, (2) the fluorides of hydrocarbons having at least a hydrogen-carbon moiety in a molecule and having an anionic elimination group bonded to a carbon next to a carbon bonded to the hydrogen-carbon moiety, (3) unsaturated hydrocarbons having only choline and/or bromine as a substituent group, and (4) saturated hydrocarbons having two or more carbons which have only chlorine and/or bromine as a substituent group.

[8] A detection method according to [7], characterized in that the fluorides of unsaturated hydrocarbons described in above (1), or the fluorides of hydrocarbons described in above (2) which has at least a hydrogen-carbon moiety in a molecule and has an anionic elimination group bonded to a carbon next to a carbon bonded to the hydrogen-carbon moiety are in a gas form.

[9] A detection method according to claim 7 or 8, characterized in that the reaction is performed under the conditions under which an organic substance other than the detection agent co-exists.

[10] A detection method according to any one of [7]-[9], characterized in that the method detects an optical change resulting from the reaction.

[11] A detection method according to [10], characterized in that the method detects as the above-mentioned optical change one or more of changes which are selected from absorbance, reflectance ratio, infrared vibration, emission, phosphorescence, refractive index, a liquid crystal state and photoelectron kinetic energy by X-rays.

[12] A detection method according to [10], characterized in that the method detects as the above-mentioned optical change 50 ppm or less of the concentration of the halide by using the absorbance change or the reflectance ratio change in the ultraviolet visible light region.

[13] A detection method according to [10], characterized in that the method detects as the above-mentioned optical change 5 ppm or less of the concentration of the halide by using the absorbance change or the reflectance ratio change in the ultraviolet visible light region.

[14] A detection method according to any one of [7]-[9], characterized in that the method detects a mass change by the above mentioned changes.

[15] A detection method according to claim 14, characterized in that the method captures the mass change by the reaction of the above mentioned halide with a membrane surface as the frequency change of a vibrating member surface or the resonance frequency change of a QCM substrate where the above mentioned detection agent is at least absorbed on the membrane surface of the vibrating member surface or the QCM substrate.

[16] A detection method according to any one of [7]-[1,5], characterized in that the fluorides of unsaturated hydrocarbons are C₅F₈, C₄F₆ or a mixture thereof.

[17] A detection method according to [16], characterized in that the above mentioned C₅F₈ is octafluorocyclopentene.

[18] A detection method according to [16], characterized in that the above mentioned C₄F₆ is hexafluorobutadiene, hexafluorocyclobutene or a mixture thereof.

[19] A detection method according to any one of [7]-[15], characterized in that the fluorides of unsaturated hydrocarbons having at least a hydrogen-carbon moiety in a molecule and having an anionic elimination group bonded to a carbon next to a carbon bonded to the hydrogen-carbon moiety is C₅F₈H₂.

[20] A detection method according to [19], characterized in that the above mentioned C₅F₈H₂ is octafluorocyclopentane.

[21] A detection method according to [19], characterized in that the above mentioned C₅F₈H₂ is 1H,2H-octafluorocyclopentane, 1H,1H-octafluorocyclopentane, 1H,3H-octafluorocyclopentane or a mixture thereof.

[22] A sensor for detecting a halide, characterized in that a detection agent according to any one of [1]-[6] is used in a detector of the sensor, wherein the sensor is for detecting a halide of any one selected from (1) the fluorides of unsaturated hydrocarbons, (2) the fluorides of hydrocarbons having at least a hydrogen-carbon moiety in a molecule and having an anionic elimination group bonded to a carbon next to a carbon bonded to the hydrogen-carbon moiety, (3) unsaturated hydrocarbons having only choline and/or bromine as a substituent group and (4) saturated hydrocarbons having two or more carbons which have only chlorine and/or bromine as a substituent group.

[23] A sensor according to [22], characterized in that the above mentioned detection agent is absorbed into a porous material.

[24] A sensor according to [23], characterized in that the above mentioned porous material is a meshed cellulose, polymer or porous alumina.

[25] A sensor according to [22], characterized in that a polymer containing the above mentioned detection agent is used.

### THE EFFECT OF THE INVENTION

According to the present invention, it is possible to detect the gaseous fluorides of hydrocarbons such as C₅F₈ or C₄F₆ and/or the gaseous fluorides of hydrocarbons having at least a hydrogen-carbon moiety in a molecule and having an anionic elimination group bonded to a carbon next to a carbon bonded to the hydrogen-carbon moiety, easily and quickly not at a high temperature (practically, 80 degree or less), such as mostly at a room temperature or a temperature closer thereto, and further without interference with hindrance gases from fluorine liquids. Also, a method according to the present invention can be used in a sensor, alarm device, measurement device or the like, which efficiently detects the gaseous fluorides of hydrocarbons such as C₅F₈ or C₄F₆, some of which are used in an etching process, or the gaseous fluorides of hydrocarbons, some of which are known as hydrofluorocarbon (HFC), having at least a hydrogen-carbon moiety in a molecule and having an anionic elimination group bonded to a carbon next to a carbon bonded to the hydrogen-carbon moiety. Further, according to the present invention, it is possible to easily and quickly detect the gaseous unsaturated hydrocarbons having only choline and/or bromine as a substituent group, or the gaseous saturated hydrocarbons having two or more of carbons having only choline and/or bromine as a substituent group. Furthermore, the present invention can be applied to techniques for selectively decompose and remove these series of the compounds.

### BRIEF DESCRIPTION OF THE DRAWINGS

FIG. 1 is a graph showing a time-dependency of the optical change when using 0.1 ppm of C₅F₈ in Example 12.

FIG. 2 is a graph showing a time-dependency of the optical change when using 2 ppm of C₅F₈ in Example 14.

FIG. 3 is a graph showing a time-dependency of the mass change when using 2 ppm of C₅F₈ and 30 ppb of C₅F₈ in Examples 29 and 30.

### EMBODIMENTS OF THE PRESENT INVENTION

The present invention is characterized in that it detects the fluorides of unsaturated hydrocarbons such as C₅F₈ or C₄F₆ by contacting the fluorides with a compound represented by the general formula (I) shown below and causing a selective reaction therebetween, and using an optical change and/or a mass change resulting therefrom.

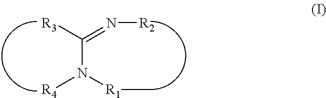

The compound represented by the general formula (I) is a nitrogen compound forming a cyclic compound having at least two rings in which amidine backbone R₃C(═N—R₂)NR₁R₄ is centered and in which R₁-R₂ and R₃-R₄ mainly form a methylene chan.

That is, in the general formula (I) shown above, each of R₁, R₂, R₃ and R₄ represents the first site to be bonded to a nitrogen or carbon in the amidine backbone, is basically a methylene group (CH₂) and may be substituted with any of other heteroatoms. In the general formula (I) shown above, each of R₁, R₂, R₃ and R₄ may be a heteroatom such as a nitrogen atom (N), oxygen atom (O) or sulfur atom (S) each of which may have a substituent group.

A substituent group formed of a hydrocarbon group generally known, a polymer or oligomer having such hydrocarbon group may be present or introduced between R₁ and R₂ or between R₃ and R₄, and those substituent group may form another cyclic moiety, thereby forming three rings in the compound.

Here, the phrase “a hydrocarbon group generally known” has a concept meaning that it may include a substituent group generally known in organic chemistry, a component selected from a heteroatom, typical element, transition metal, alkali metal, alkaline earth metal, and ions thereof, and include any of those which may form a heterocyclic ring. Therefore, examples of the above mentioned hydrocarbon group include a group of compounds in which a substituent group such as alkyl, alkene, alkyne, phenyl, naphthyl, anthracenyl, hydroxy, alkoxy, aldehyde, ketone, ether, crown ether, polyethylene glycol, carboxylic acid ester, carboxylate, acetal, epoxy, amino, amido, imino, nitro, cyano, isocyano, thioisocyano, azo, azoxy, porphyrins, thiol, sulfide, disulfide, sulfinic acid ester, sulfonic acid ester, a salt of any of those acids, pyridine, pyrrole, pyrrolidine, piperidine, morpholine, piperazine, quinoline, thiophene, furan, and transition metals complex may be bonded to or inserted into somewhere in any of the compounds, or in which an organic polymer may be bonded to any of the compounds via any of those substituent group.

Some examples of a nitrogen compound having at least two rings as represented by the general formula (I) will be shown without any intension to limit the compound to the examples. These compounds may be compounds already publicly known as basic reagents used in organic synthesis, or those derived from such compounds.

### (1) 1,5-diazabicyclo[4,3,0]non-5-ene (DBN)

This compound forms a nitrogen compound having two rings in which R₁-R₂ and R₃-R₄ each forms three methylene chains.

### (2) 1,8-diazabicyclo[5,4,0]undec-7-ene (DBU)

This compound forms a nitrogen compound having two rings in which R₁-R₂ forms three methylene chains and R₃-R₄ forms five methylene chains.

### (3) 4,4-dimethyl-DBN

This compound forms a nitrogen compound having two rings which is a substituted derivative whose basic backbone is the above-mentioned DBN, which has two methyl groups at position 4 as a substituent group.

### (4) 4,7-dimethyl-DBN

This compound forms a nitrogen compound having two rings which is a substituted derivative whose basic backbone is the above-mentioned DBN, which has one methyl group at each of positions 4 and 7 as a substituent group.

### (5) 4-phenyl-DBN

This compound forms a nitrogen compound having two rings which is a substituted derivative whose basic backbone is the above-mentioned DBN, which has one phenyl group at position 4.

### (6) 3,4,6,7,8,9-hexahydro-2H-pyrido[1,2-a]pyrimidine

This compound forms a nitrogen compound having two rings in which R₁-R₂ forms three methylene chains and R₃-R₄ forms four methylene chains.

### (7) 1,3,4,6,7,8-hexahydro-2H-primido[1,2-a]pyrimidine (HPP)

This compound forms a nitrogen compound having two rings in which R₃ is in a form of amine nitrogen N—H, three methylene chains are present to R₄, and R₁-R₂ forms three methylene chains.

### (8) 1,3,4,6,7,8-hexahydro-1-methyl-2H-primido[1,2-a]pyrimidine (MeHPP)

This compound forms a nitrogen compound having two rings in which R₃ is in a form of amine nitrogen N-Me (a methyl group), three methylene chains are present to R₄, and R₁-R₂ forms three methylene chains.

### (9) tetramisole (another name is Levamisole)

This compound forms a nitrogen compound having two rings in which R₃ is sulfur, two methylene chains are present to R₄, R₁-R₂ forms two methylene chains, and R₂ has one substituted phenyl group.

Substituted derivatives of DBN which is a nitrogen compound having at least two rings at which an amidine backbone is centered, DBU, 3,4,6,7,8,9-hexahydro-2H-pyrido[1,2-a]pyrimidine, HPP, tetramisole include forms having a substituent group in the cyclic moiety such as the above mentioned (3), (4), (5), and (8), and include forms having a methylene chain or other heteroatoms which are inserted to R₁-R₂ and R₃-R₄, provided that they do not overlap each other in the compounds of (1)-(9).

As mentioned above, a nitrogen compound represented by the general formula (I) having at least two rings at which an amidine backbone is centered may be a nitrogen compound having at least two rings at which an amidine backbone in which a substituent group formed of a oligomer or polymer is bonded or inserted to R₁-R₂ or R₃-R₄, and one example of those is a polymer molecule in which a polystyrene derivative is covalently bonded to R₁, namely, JANDAJEL(trademark)-1,3,4,6,7,8-hexahydro-2H-primido[1,2-a]pyrimidine.

The nitrogen compound represented by the general formula (I) having at least two rings at which an amidine backbone is centered may also include some forms in which two or more of the nitrogen compounds represented by the general formula (I) having at least two rings at which an amidine backbone is centered are bounded to each other via the above mentioned substituent groups, inserted oligomer or polymer to form a dimer, trimmers or tetramer.

As mentioned above, a nitrogen compound represented by the general formula (I) having at least two rings at which an amidine backbone is centered may include a compound having additional cyclic substituent groups in R₁-R₂ or R₃-R₄, thereby constituting a nitrogen compound having three or more of rings, and one example of those is 7-imino-3,4,6,7-tetrahydro-2H-pyrimido[2,1-a]isoquinoline. This compound constitutes a three-cyclic nitrogen compound in which an imine substituent group is inserted in the middle of R₃-R₄ where four carbons are present, and a benzene ring is inserted to R₄.

A compound to be detected in the present invention is a halide selected from a series of halogenated hydrocarbons which include as a substituent group fluorine, chlorine and bromine among halogens from the group 17 in the periodic table, which is a halide selected from the group consisting of: (1) the fluorides of unsaturated hydrocarbons; (2) the fluorides of unsaturated hydrocarbons having at least a hydrogen-carbon moiety in a molecule and having an anionic elimination group bonded to a carbon next to a carbon bonded to the hydrogen-carbon moiety; and (3) the unsaturated hydrocarbons having only chlorine and/or bromine as a substituent group; and (4) the saturated hydrocarbons having two or more carbons which have only chlorine and/or bromine as a substituent group.

The fluorides of unsaturated hydrocarbons to be detected in the present invention according to the above mentioned (1) are in most cases compounds in a gas-state which are composed of at least carbon and fluorine and which have at least a compound with a double bond between carbons and/or a triple bond between carbons, that is, such vaporized, gaseous fluorides of unsaturated hydrocarbons.

In addition, those in a form of liquid can be included in the compound to be detected. As can be understood from their structure with a double carbon bond and/or triple carbon bond, these chemical species are composed of at least two carbon atoms, and therefore, the fluorides of unsaturated hydrocarbons to be detected in the present invention are compounds which necessarily contain at least two or more carbons. It is intended that these compounds includes any compounds whose any atoms such as chlorine, bromine, iodine, oxygen, sulfur and nitrogen, or hydrocarbon groups or functional groups generally known as mentioned above such as a carboxyl group, an alkoxy group and formyl group are substituted. These compounds include fluorinated hydrocarbons which are a series of gaseous compounds discussed in the Koyo Protocol.

For example, these compounds include C₂F₄, C₃F₆, C₄F₆, c-C₄F₈, c-C₅F₈, CF₃OCF═CF₂, C₂F₅OCF═CF₂ (“c-” represents “cyclic”, c-C₅F₈ is the same as C₅F₈ as mentioned above, C₄F₆ includes the two kinds mentioned above; they are called octafluorocyclopentene (C₅F₈), hexafluorobutadiene (C₄F₆), hexafluorcyclobutene (C₄F₆), respectively). Also, part of those compounds may be used as a refrigerant, blowing agent, cleaning agent or an etching gas in the industry. These series of compounds in part are called PFC (perfluorocarbon) having an unsaturated bond which are accused for environmental issues. These series of compounds include a linear fluorine compound having an ether group where oxygen is bonded, thus are concerned for environment load and human health. The present invention can be applied to detection of these compounds to be detected, for example, for an examination or alert of leak, or measurement of concentrations thereof.

The halides to be detected in the present invention include the fluorides according to the above mentioned (2) which cause the same reaction as the fluorides of unsaturated hydrocarbons as mentioned above. The fluorides include a compound having at least a hydrogen-carbon moiety in a molecule and having an anionic elimination group (for example, s substituent group such as halogen such as fluorine and chlorine, alkoxy, ether, chalcogen-containing group such as sulfide, carboxylic acid, and sulfonic acid) bonded to a carbon next to a carbon bonded to the hydrogen-carbon moiety, and such compounds also include a compound whose functional group other than the anionic elimination group is substituted, which is generally known to include a group such as chlorine, bromine, iodine, oxygen, sulfur and nitrogen, or a carboxyl group, an alkoxy group or formyl group. These compounds include a series of fluorinated hydrocarbons which are gaseous compounds discussed in the Kyoto protocol. Those of liquid may also be included as targets to be detected. In view of their structures, and because these chemical species are composed of at least two carbon atoms, the compound to be detected by the present invention which has at least a hydrogen-carbon moiety in a molecule and having an anionic elimination group bonded to a carbon next to a carbon bonded to the hydrogen-carbon moiety is a compound which necessarily contains two or more carbons.

Examples of this compound include CF₃CHF₂, CHF₂CHF₂, CF₃CHFCF₃, CF₃CF₂CHF₂, CHF₂CF₂CHF₂, CF₃OCHFCF₃, c-C₅F₈H₂.

Some of the compounds having at least a hydrogen-carbon moiety in a molecule and having an anionic elimination group bonded to a carbon next to a carbon bonded to the hydrogen-carbon moiety and the above-mentioned examples of the compound may be used as a refrigerant in an air conditioner, a car, a refrigerator, freezer, etc. for personal or business use, or as a blowing agent to form insulation materials in a construction site, or as a cleaning agent for electronic devices. Some of those may be used as an etching gas, cleaning agent or cooling agent in a semiconductor process. These series of compounds include so-called HFC (hydrofluorocarbons) and HCFC (hydrochlorofluorocarbons).

A color reaction may occur by contacting these fluorides with a nitrogen compound having at least two rings at which an amidine backbone is centered as represented by the above mentioned general formula (I), thereby allowing the detection using the optical change. In addition, most of the fluorides to be detected by the present invention are gaseous, whereas some of those are liquids, both of which can be detected in a similar manner. The present invention can be applied to the detection, for example, in leakage check or alarm, a concentration measurement, etc.

The compounds to be detected in the present invention include, in addition to the fluorides as mentioned in the above (1) and (2), the unsaturated hydrocarbons having only chlorine and/or bromine as a substituent group as mentioned in the above (3), and the saturated hydrocarbons having two or more carbons which have only chlorine and/or bromine as a substituent group as mentioned in the above (4).

That is, the unsaturated hydrocarbons having only chlorine and/or bromine as a substituent group as mentioned in the above (3) mean that they include such compound having only chlorine as a substituent group in a molecule, such compound having only bromine as a substituent group in a molecule, and such compound having a chlorine and bromine as substituent groups in a molecule, among such unsaturated hydrocarbons having carbon-carbon double bonds and/or carbon-carbon triple bonds

These compounds may be used as, for example, organic solvents for industrial use, starting materials for organic synthesis, or detergents.

The saturated hydrocarbons having two or more carbons which have only chlorine and/or bromine as a substituent group as mentioned in the above (4) mean that they include such compound having at least hydrogen and only chlorine as a substituent group in a molecule, such compound having at least hydrogen and only bromine as a substituent group in a molecule, and such compound having at least hydrogen and only chlorine and bromine as substituent groups in a molecule, among such saturated hydrocarbons having two or more carbons.

They include in part, for example, organic solvents being subject to Ordinance on the Prevention of Organic Solvent Poisoning, and chlorocarbons (the production and consumption thereof are prohibited by the Montreal Protocol).

Some of these compounds may be used as organic solvents or solvents for dissolving reactants or in organic synthesis, or as a refrigerant in an air conditioner in a car, a refrigerator, a freezer, or the like. Since some of these compounds include a compound similar to halon analogs there are concerns about environmental or human health issues due to the contamination or leakage in the air in a process of removal, decomposition, recovery or treatment of the compounds, in which the detection of these compounds is important. The present invention makes it possible to detect these chlorides and/or bromides where the detection targets are in a form of gas or liquid in a similar manner. The present invention may be applied to the detection of these compounds, for example, in their leakage check, alarm, or concentration measurement.

The nitrogen compound having at least two rings at which an amidine backbone is centered as represented by the general formula (I) can be used as a mixture in which other organic substances coexist.

The organic substances which may be mixed include, for example, generally-known organic solvents (alcohols such as ethanol, ethylene glycol, glycerin, amides such as dimethyl formamide (DMF), N-methyl-pyrrolidone (NMP), hexamethylphosphoramide (HMPA), and ethers such as tetrahydrofuran (THF) or dioxane), organic liquids such diisopropylamine (for LDA), trybutylaminie, dicyclohexylmethylamine or pentamethylpiperidone, organic solids such as ureas, organic polymers such as cellulose, polyethylene, polybutadiene, polyethylene acrylate or polyimide poly-benzoic acid, ionic liquids such as pyridinium ion, imidazole ion, a nitrogen compound or phosphorus compound. In particular, the ionic liquids has an extremely lower vapor pressure and can prevent the concentration alteration of detecting agents and the total mass alteration in a mixture, and thus can stably and accurately detect the fluorides of gaseous unsaturated hydrocarbons, the fluorides of gaseous hydrocarbons having at least a hydrogen-carbon moiety in a molecule and having an anionic elimination group bonded to a carbon next to a carbon bonded to the hydrogen-carbon moiety, chloride derivatives or bromides derivatives thereof.

The nitrogen compound having at least two rings at which an amidine backbone is centered as represented by the general formula (I) can be contained in the above mentioned detection agent in the range of 0.1 to 99.9 mass %, preferably in the range of 5 to 80 mass %. From the viewpoint of control of the reactivity, the range of 10 to 60 mass % is most preferred.

For the reaction for the detection, the nitrogen compound having at least two rings at which an amidine backbone is centered may contact with the above mentioned gaseous fluorides to be detected. The manner of use of the compounds may include any of forms of using the compounds in a form of liquid in which they are dissolved, applying the liquid onto a substrate, immersing a porous material into the liquid, or applying a polymer containing the compound onto a substrate. The forms in which the compounds are contained mean to include any forms in which the compounds are physically absorbed into certain member or surface to be physically impregnated therein, or in which the compounds are boned to a substrate or member made of an oligomer or polymer by chemical bonds including an ionic bond, a hydrogen bond or coordination bond, whereby the compounds are present thereon.

The embodiments of the detections which may be performed in a variety of these forms include, for example any of the following embodiments:
(1) an embodiment in which a gas to be detected is bubbled into a liquid which contains the nitrogen compound having at least two rings at which an amidine backbone is centered;
(2) an embodiment in which a gas to be detected is sprayed to a polymer membrane which contains the nitrogen compound having at least two rings at which an amidine backbone is centered;
(3) an embodiment in which a gas to be detected is passed through cellulose which contains the nitrogen compound having at least two rings at which an amidine backbone is centered;
(4) an embodiment in which a gas to be detected is sprayed to a tape or sheet which contains the nitrogen compound having at least two rings at which an amidine backbone is centered;
(5) an embodiment in which a gas to be detected is sprayed to or passed through a meshed tape or sheet which contains the nitrogen compound having at least two rings at which an amidine backbone is centered;
(6) an embodiment in which a gas to be detected is passed through a tube in which beads or particles are enclosed, which contain the nitrogen compound having at least two rings at which an amidine backbone is centered;
(7) an embodiment in which a gas to be detected is sprayed to or passed through a tape onto which beads or particles are supported where they contain the nitrogen compound having at least two rings at which an amidine backbone is centered; and
(8) any embodiment including (1)-(7) in which the detection target is in a form of liquid.

In the embodiments, the polymer membrane, cellulose, tape or sheet as described in the above mentioned (1)-(7) contains the nitrogen compound having at least two rings at which an amidine backbone is centered. They include any embodiments using any forms of an oligomer, polymer, or physical or chemical bonding as mentioned above. Anything containing the nitrogen compound having at least two rings at which an amidine backbone is centered as explained above can be a detection target for a detection agent of the present invention.

A rate at which a gas to be detected flows, namely, the flow rate is set in the embodiments in which the gas to be detected is spayed, passed through or bubbled, whereas the flow rate is not particularly limited. For the purpose of promoting the reaction, the flow rate is preferably 800 mL/minute. In view of the apparatus, 200-2000 mL/minute is preferred. In view of saving energy, 20-500 mL/minute is preferred.

In the present invention, the optical change or mass change is detected and measured. The changes may occur with an unique reaction which smoothly progresses at a room temperature or a temperature near the room temperature using the contain the nitrogen compound having at least two rings at which an amidine backbone is centered. The reaction temperature is preferably 80 degree or less from the practical point of view. The reaction with a detection target smoothly progresses at a room temperature of around 25° C., and thus, such room temperature can be used, while in some cases, they can be heated in the range of 80° C. or less. For the purpose of signal stabilization, the temperature is preferably constant temperature selected within 30-45° C., and the temperature of around 50° C. is preferred for less reactive chlorides, and the temperature of around 70° C. is preferred for less reactive bromides.

In the present invention, any of optical changes resulting from a molecule reaction can be observed as the optical change. For example, the change in absorbance may occur due to a change in transmittance of light having a wavelength in the ultraviolet visible light region. The ultraviolet visible light region used in the present invention means a range of the visible light from the ultraviolet light region including vacuum ultraviolet to purple, blue, green, yellow, orange and red. As to the wavelength, the range of 200-800 nm is referred. In view of a light source, particularly, the range of 300-700 nm is most preferred. To detect a change in those colors, the detection or examination can be performed by direct visual observation or by colorimetric measurement of the color change by using a device.

A reflectance ratio change is a change of reflectance ratio which occurs due to a change in a transmittance of light having a wavelength in the ultraviolet visible light region or a change of light scattering on a surface; that is, resulting from a change in the degree of reflectance of light from a light source, which may strongly be associated with the change of absorbance. Similar to the change of absorbance, the ultraviolet visible light region means a range of the visible light from the ultraviolet light region including vacuum ultraviolet to purple, blue, green, yellow, orange and red. As to the wavelength, the range of 200-800 nm is referred. In view of a light source, particularly, the range of 300-700 nm is most preferred. To capture the change of reflectance ratio, a value of reflectance ratio in the wavelength in which the reflectance ratio may not alter by the reaction can be used as a criterion standard value. To be compared with the criterion standard value as a control, a value of reflectance ratio in the wavelength in which it may alter by the reaction can be measured in the method. In addition, the method is not limited to those mentioned above, any other methods useful in capturing the reflectance ratio change in the reflection spectrum can be applied, which may include to simply set a single wavelength to be detected, to set plural wavelengths that involve the change of reflectance ratio for the detection, or to use an integration value in certain wavelength region.

A change in an infrared vibration occurs due to changes of stretch or vibration in each bond in a molecule in the infrared region. The infrared vibration used in the present invention is vibration in the region from infrared to near-infrared, or further the region of far-infrared. In a case of Kaiser, the range of 10-4000 cm⁻¹ is preferred. In view of the measurement, particularly, the range of 1000-1500 cm⁻¹ is most preferred.

A change in fluorescence or phosphorescence emissions is a change of light emitted by the energy transferring from the excited state to the ground state of a molecule which changes together with the reaction of the molecule. In the present invention, the excited state is generated by excitation light. Therefore, the regions of light to be used are the same as those used for the change in the absorbance or reflectance ratio. The change in fluorescence or phosphorescence emissions may increase or decrease in some cases. A change of refractive index occurs due to a change in the dielectric constant in the portion which changes with the reaction of the molecule. In most cases, the measurement is performed in the air. The light to preferably be used is those in the ultraviolet visible light region, and the change in the refractive index value is preferably in the range of 0.1-3.2. A change of the liquid crystal state occurs due to a change of an orientation state of a molecule that changes with the reaction of the molecule, and in particular, the change between an isotropic liquid crystal and a nematic liquid crystal or smectic liquid crystal is used. A polarized light in the ultraviolet visible light region is used.

A change in the photoelectron kinetic energy by x-ray occurs due to a change of the state of atom in a molecule, which changes with the reaction of the molecule. The change of the photoelectron kinetic energy is observed and measured. As a light source, x-ray of MgKa or AlKa is preferably used. In view of the reaction, the change of the photoelectron kinetic energy is measured in the range of 200-800 eV. It is possible to detect the gaseous halides with high sensitivity by using one or more of the above mentioned optical changes singularly or in combination.

In the present invention, it is possible to detect the gaseous halides with high sensitivity where the nitrogen compound having at least two rings at which an amidine backbone is centered is absorbed on a surface of a vibrating object or a QCM (Quarts Crystal Microbalance) substrate. Then, the vibration frequency change or the mass change of the above mentioned vibrating surface resulting from the reaction of the above mentioned gaseous fluorides with the membrane surface is captured as the change of the resonance frequency. The above mentioned vibrating object is a material which vibrates at an appropriate number of frequencies per unit of time, for example, dozens to several GHz. Some forms of those include a cantilever or rod shape made of a metal or silicon material, or a small plate shape of nm levels. As the resonance frequency of the above mentioned QCM substrate can be set to a frequency as generally known, for example, dozens to several GHz, with reference to the already established technique or method.

According to the present invention, the gaseous halides which are the detection target can be detected in a short period of time. For example, 2 ppm of the gaseous halides can be detected within one minute. Further, 0.1 ppm or less of those can be detected within one minute, depending on the flow rate of the gas or the manner of spraying.

According to the present invention, the gaseous halides which are the detection target can be detected with high sensitivity. For example, 50 ppm of the gas can be detected. For practical use, the detection capable at a 5 ppm concentration is preferred and is possible. In view of the management criterion concentration, the detection capable at a 2 ppm concentration is preferred and is possible. For commercialization and high reliability, the detection possible at 0.1 ppm or less within one minute is preferred and is possible.

The present invention measures an optical change or mass change with a unique reaction which smoothly progresses at a room temperature, practically at a temperature of 80° C. or less, using the nitrogen compound having at least two rings at which an amidine backbone is centered. This utilizes a group of reactions unique to organic molecules, whereby it exhibits characteristic selectivity. That is, the gaseous fluorides which are the detection target can be selectively detected with high sensitivity, and it is possible without detection errors in most cases where perfluorocarbon exists at an excessive amount, as there is no reactivity to those gaseous or liquid fluorides of saturated hydrocarbons which are hindrance gases such as from fluorine liquids many of which are used in detergents, insulating materials, refrigerants, etc., for example, FLUORINERT (registered trademark), (inactive fluorine liquids; the component is perfluorocarbon), GALDEN (registered trademark) (inactive fluorine liquids; the component is perfluorocarbon), NOVECK (registered trademark) (the component is HFE hydrofluoroether).

The present invention measures an optical change or mass change with a unique reaction which smoothly progresses at a temperature near a room temperature using the nitrogen compound having at least two rings at which an amidine backbone is centered. The process of signals can be performed using a device, persona computer, software, or in combination thereof, and types or forms of devices are not limited. The measurement is possible utilizing those currently existing or already-made. The optical change can be captured as a change in the peak intensity of specific wavelength in each spectrum, a change in an integration value or spectrum shape in certain wavelength region. In this manner, it is possible to capture the change with precision by setting a criterion value for the peak intensity of specific wavelength in each spectrum, a change in an integration value or spectrum shape in certain wavelength region. By combining of these, eventually, it is possible to selectively detect the gaseous fluorides which are the detection target with high sensitivity.

### EXAMPLES

Examples according to the present invention will be explained below without any intention to limit the scope of the present invention by the examples. Any modifications, any other embodiments and examples that fall within the technical idea of the present invention can be included in the scope of the present invention.

### Example 1

About 30 mg of DBU was mixed with about 1 mL of Nujol (liquid paraffin). When 0.1 mL of the 10 mM concentration of a cooled tetrahydrofuran solution of C₅F₈ was added to the mixture, a color change was observed in around 450 nm±100 nm which is the ultraviolet visible absorption wavelength band. The ultraviolet visible light was measured by using OceanOptics SpectraSuite. As a light source for the ultraviolet visible light, a Hg—Xe lamp was used. The same method as here was used in the other examples explained below.

Signals of 1100-1300 cm⁻¹ unique to C-F vibration could be observed from the infrared absorption spectrum of the substance whose color has changed. This change could also be detected in observation with X-ray photoelectron spectroscopy. A peak at about 690 eV unique to F1s could be detected, which corresponds to the photoelectron kinetic energy by the reaction of C₅F₈ with DBU. The measurements of the infrared absorption and the X-ray photoelectron spectroscopy were performed by using BioRad and ESCA-KM, respectively. The same method as here was used in the other examples explained below.

As shown above, in each of the above methods for observing the optical change, C₅F₈ could be detected, which is one kind of the fluorides of unsaturated hydrocarbons in a form of liquid.

### Example 2

About 40 mg of DBU was dissolved into about 1 mL of Nujol (liquid paraffin), and absorbed on KBr. The 50 ppm concentration of dried nitrogen-based C₅F₄ in a form of gas was taken into a syringe. When the C₅F₈ gas was sprayed to the KBr, a color change was observed in around 440 nm±100 nm which is the ultraviolet visible absorption wavelength band.

Signals of 1100-1300 cm⁻¹ unique to C-F vibration could be observed from the infrared absorption spectrum of the substance whose color has changed. This change could also be detected in observation with X-ray photoelectron spectroscopy. A peak at about 690 eV unique to F1s could be detected, which corresponds to the photoelectron kinetic energy by the reaction of C₃F₈ with DBU.

As shown above, in each of the above methods for observing the optical change, C₅F₈ could be detected, which is one kind of the fluorides of unsaturated hydrocarbons in a form of liquid.

### Example 3

About 40 mg of DBN was mixed with about 1 mL of Nujol (liquid paraffin). When 0.1 mL of a THF solution of C₅F₆ which was the 90 mM concentration of a cooled hexafluorobutadiene (also in the other examples below) was added to the mixture, a color change was observed in around 450 nm±100 nm which is the ultraviolet visible absorption wavelength band.

Signals of 1100-1300 cm⁻¹ unique to C-F vibration could be observed from the infrared absorption spectrum of the substance whose color has changed. This change could also be detected in observation with X-ray photoelectron spectroscopy. A peak at about 690 eV unique to F1s could be detected, which corresponds to the photoelectron kinetic energy by the reaction of C₅F₆ with DBN.

As shown above, in each of the above methods for observing the optical change, C₅F₆ could be detected, which is one kind of the fluorides of unsaturated hydrocarbons in a form of liquid.

### Example 4

About 40 mg of DBN was dissolved into about 1 mL of Nujol, and absorbed on KBr. 10 mL of the 10 ppm concentration of gaseous dried nitrogen-based C₅F₈ and 10 mL of the 10 ppm concentration of C₅C₆ were mixed at the ratio of 1:1, and the mixture was taken into a syringe. When the mixture was sprayed to the KBr surface, a color change in yellow was observed in around 420 nm±100 nm which is the ultraviolet visible absorption wavelength band.

Signals of 1100-1300 cm⁻¹ unique to C-F vibration could be observed from the infrared absorption spectrum of the yellow substance. This change could also be detected in observation with X-ray photoelectron spectroscopy. A peak at about 690 eV unique to F is could be detected, which corresponds to the photoelectron kinetic energy by the reaction of C₅F₈ and C₅C₆ with DBN.

As shown above, in each of the above methods for observing the optical change, the mixed gas of C₅F₈ and C₅C₆ could be detected, each of which is one kind of the fluorides of unsaturated hydrocarbons in a form of gas.

### Example 3

About 50 mg of DBU was mixed with 1 mL of N-methyl-2-pyrrolidone (NMP). When 0.5 mL of the 20 mM concentration of a THF solution of C₅F₈ was added to the mixture, a color change was observed in around 420 nm±100 nm which is the ultraviolet visible absorption wavelength band.

As shown above, in one of the methods for observing the optical change, C₅F₈ could be detected, which is one kind of the fluorides of unsaturated hydrocarbons in a form of liquid.

### Example 6

About 10 mg of DBN was dissolved into about 1 mL of acetonitrile. 10 mL of the 5 ppm concentration of gaseous dried nitrogen-based C₅F₈ and 10 mL of the 5 ppm concentration of C₅C₆ were mixed at the ratio of 1:1, and the mixture was taken into a syringe. When the mixture was bubbled into the DBN solution, a change in the ultraviolet visible absorption was observed in around 400 nm±100 nm.

In one of the methods for observing the optical change, the mixed gas of C₅F₈ and C₅C₆ could be detected, each of which is one kind of the fluorides of unsaturated hydrocarbons in a form of gas.

### Example 7

About 10 mg of DBN was absorbed into cellulose having about 3 μm of mesh diameter. When the 2 ppm concentration of dried nitrogen-based C₅C₈ gas in a gas state was sprayed to the cellulose at 800 mL/minute of the flow rate, a change in reflectance ratio was observed in the ultraviolet visible absorption wavelength region around 400 nm±100 nm.

As shown above, in one of the methods for observing the optical change, C₅F₈ which is one kind of the fluorides of unsaturated hydrocarbons in a form of gas could be detected at the level of 2 ppm, by using the embodiment in which at least DBN was contained and present together with the cellulose which is an organic substance other than DBN.

### Example 8

About 10 mg of DBN was absorbed into cellulose having about 3 μm of mesh diameter. The 2 ppm concentration of C₅C₈ gas in a gas state was sprayed to the cellulose at 800 mL/minute of the flow rate for one minute, where the gas was an indoor air-based gas containing about 30000 ppm (3%) of excessive GALDEN HT70. Thereafter, the detection was conducted, and a change in reflectance ratio was observed in the ultraviolet visible absorption wavelength region around 400 nm±100 nm.

As shown above, in one of the methods for observing the optical change, C₅F₈ which is one kind of the fluorides of unsaturated hydrocarbons in a form of gas could be detected at the level of 2 ppm, by using the embodiment in which at least DBN was contained and present together with the cellulose which is an organic substance other than DBN, despite the presence of the hindrance gas, perfluoroether.

### Example 9

About 10 mg of DBN was absorbed into cellulose having about 3 μm of mesh diameter. When the 2 ppm concentration of C₅C₈ gas in a gas state was sprayed to the cellulose at 800 mL/minute of the flow rate, which was an indoor air-based gas containing about 40000 ppm (4%) of excessive FLUORINERT FC-84, a change in reflectance ratio was observed in the ultraviolet visible absorption wavelength region around 400 nm±100 nm.

As shown above, in one of the methods for observing the optical change, C₅F₈ which is one kind of the fluorides of unsaturated hydrocarbons in a form of gas could be detected at the level of 2 ppm, by using the embodiment in which at least DBN was contained and present together with the cellulose which is an organic substance other than DBN, despite the presence of the hindrance gas, perfluorocarbon.

### Example 10

About 10 mg of DBN was absorbed into cellulose having about 3 μm of mesh diameter. When the 2 ppm concentration of C₅C₈ gas in a gas state was sprayed to the cellulose at 800 mL/minute of the flow rate, which was an indoor air-based gas containing about 35000 ppm (3.5%) of excessive NOVECK 7100, a change in reflectance ratio was observed in the ultraviolet visible absorption wavelength region around 400 nm±100 nm.

As shown above, in one of the methods for observing the optical change, C₅F₈ which is one kind of the fluorides of unsaturated hydrocarbons in a form of gas could be detected at the level of 2 ppm, by using the embodiment in which at least DBN was contained and present together with the cellulose which is an organic substance other than DBN, despite the presence of the hindrance gas, perfluoroether.

### Example 11

About 500 mg of DBN and 800 mg of polybutadiene solution dissolved with 10 mL of toluene were mixed. Part of the mixture was taken, applied to a glass surface, and the THF was dried in a nitrogen atmosphere. The mixture ratio can be any other figures, and may not be limited to this example. When the 5 ppm concentration of C₅C₈ gas in a gas state was sprayed to the surface, a change in reflectance ratio was observed in the ultraviolet visible absorption wavelength region around 400 nm±100 nm.

As shown above, in one of the methods for observing the optical change, C₅F₈ which is one kind of the fluorides of unsaturated hydrocarbons in a form of gas could be detected at the level of 2 ppm, by using the embodiment in which at least DBN was contained and present together with an organic substance other than DBN, despite the presence of the hindrance gas, perfluoroether.

### Example 12

About 60 mg of DBN was mixed with about 120 mg of triisobutylamine, absorbed into cellulose having about 3 μm of mesh diameter, and placed somewhere within a gas line which was flow rate-controllable. The mixture ratio can be any other figures, and may not be limited to this example. When the 0.1 ppm concentration of an indoor air-based C₅C₈ gas in a gas state was sprayed to the cellulose at about 800 mL/minute, a change in reflectance ratio was observed in the ultraviolet visible absorption wavelength region around 400 nm±100 nm.

In this example, using 600 nm as a criterion wavelength, absolute values of a reflectance ratio change in 400 nm were plotted against time in relation to the criterion wavelength, for example. That is, in this case, C₅F₈ which is one kind of the fluorides of unsaturated hydrocarbons in a form of gas was detected by measuring the absolute values of the difference obtained by subtracting the reflectance ratio value at 600 nm from the reflectance ratio value at 400 nm in the reflectance ratio spectrum. However, conditions under which the spectrum change is captured may not limited to those in this example, and the measurement is possible to use any other flow rates, wavelengths to be measured, and integration values in certain wavelength region in any combinations thereof.

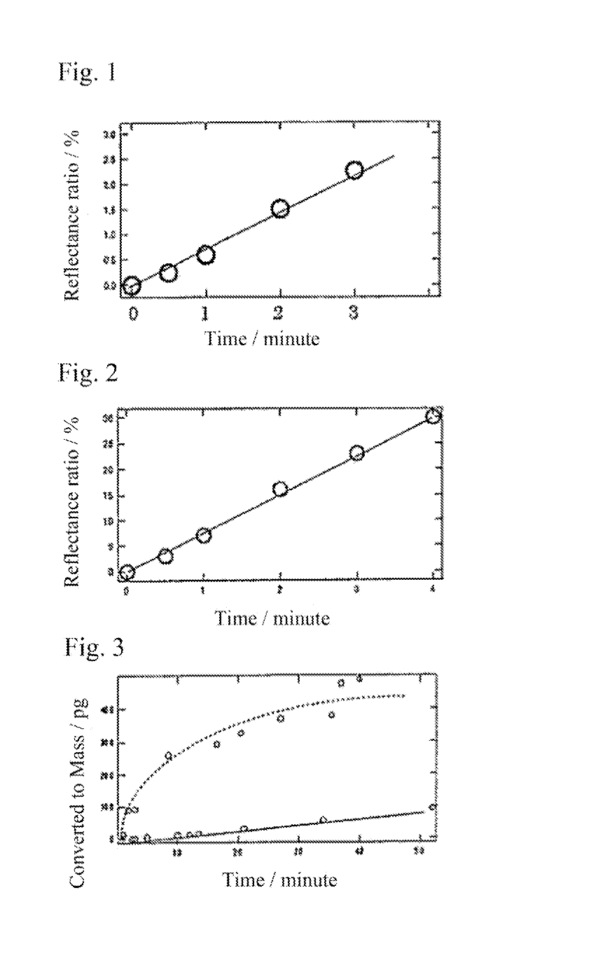

FIG. 1 is a graph showing the results. As shown in FIG. 1, the significant change in the reflectance ratio was captured within one minute, and the change in proportion to time was observed.

As shown above, in one of the methods for observing the optical change, C₅F₈ which is one kind of the fluorides of unsaturated hydrocarbons in a form of gas could be detected with high sensitivity (0.1 ppm), by using the embodiment in which at least DBN was contained and present together with an organic substance other than DBN.

### Example 13

A mixture of about 40 mg of DBN and 0.5 mL of NMP which is one kind of organic solvent was absorbed into a porous alumina plate, and placed somewhere within a gas line which was flow rate-controllable. When the 2 ppm concentration of dried nitrogen-based C₅C₈ gas in a gas state was sprayed to the alumina plate at about 800 mL/minute of the flow rate, a change in reflectance ratio was observed in the ultraviolet visible absorption wavelength region around 400 nm±100 nm.

As shown above, in one of the methods for observing the optical change, C₅F₈ which is one kind of the fluorides of unsaturated hydrocarbons in a form of gas could be detected by using the embodiment in which at least DBN was contained and present together with an organic substance other than DBN.

### Example 14

About 60 mg of DBN was mixed with about 100 mg of dichlorohexylmethylamine, absorbed into cellulose having about 3 μm of mesh diameter, and placed somewhere within a gas line which was flow rate-controllable. The mixture ratio can be any other figures, and may not be limited to this example. When the 2 ppm concentration of a dried nitrogen-based C₅C₈ gas in a gas state was sprayed to the cellulose at about 600 mL/minute, a change in reflectance ratio was observed in the ultraviolet visible absorption wavelength region around 400 nm±100 nm.

In this example, using 600 nm as a criterion wavelength, absolute values of a reflectance ratio change in 370 nm were plotted against time in relation to the criterion wavelength, for example. That is, in this case, C₅F₈ which is one kind of the fluorides of unsaturated hydrocarbons in a form of gas was detected by measuring the absolute values of the difference obtained by subtracting the reflectance ratio value at 600 nm from the reflectance ratio value at 370 nm in the reflectance ratio spectrum. However, conditions under which the spectrum change is captured may not limited to those in this example, and the measurement is possible to use any other flow rates, wavelengths to be measured, and integration values in certain wavelength region in any combinations thereof.

FIG. 2 is a graph showing the results. As shown in FIG. 2, the significant change in the reflectance ratio was captured within one minute, and the change in proportion to time was observed.

As shown above, in one of the methods for observing the optical change, 2 ppm of C₅F₈ which is one kind of the fluorides of unsaturated hydrocarbons in a form of gas could be detected by using the embodiment in which at least DBN was contained and present together with an organic substance other than DBN.

### Example 15

About 70 mg of DBU was mixed with about 90 mg of triisobutylamine, and absorbed into cellulose having about 3 μm of mesh diameter, and placed somewhere within a gas line which was flow rate-controllable. When the 2 ppm concentration of a dried nitrogen-based C₅C₆ gas in a gas state was sprayed to the cellulose at about 600 mL/minute of the flow rate, a change in reflectance ratio was observed in the ultraviolet visible absorption wavelength region around 400 nm±100 nm.

As shown above, in one of the methods for observing the optical change, C₅F₆ which is one kind of the fluorides of unsaturated hydrocarbons in a form of gas could be detected by using the embodiment in which at least DBN was contained and present together with an organic substance other than DBN.

### Example 16

About 60 mg of DBN was mixed with about 90 mg of triisobutylamine, and absorbed into cellulose having about 3 μm of mesh diameter, and placed somewhere within a gas line which was flow rate-controllable. When the 2 ppm concentration of a dried nitrogen-based C₅F₈H₂ gas in a gas state was sprayed to the cellulose at about 600 mL/minute of the flow rate, a change in reflectance ratio was observed in the ultraviolet visible absorption wavelength region around 400 nm±100 nm.

As shown above, in one of the methods for observing the optical change, C₅F₈H₂ which is fluoride in a gas state and is one kind of HFC (hydrofluorocarbon) could be detected by using the embodiment in which at least DBN was contained and present together with an organic substance other than DBN.

### Example 17

About 90 mg of DBN was mixed with about 90 mg of triisobutylamine, and absorbed into cellulose having about 3 μm of mesh diameter. The 1 ppm concentration of dried nitrogen-based C₅F₈ in a gas state, the I ppm concentration of C₅F₆ and the 1 ppm concentration of C₅F₈H₂ were mixed at the ratio of 1:1:1. When the mixture was sprayed to the cellulose at about 600 mL/minute of the flow rate, a change in reflectance ratio was observed in the ultraviolet visible absorption wavelength region around 400 nm±100 nm.

As shown above, in one of the methods for observing the optical change, the mixed gas of the gaseous fluorides could be detected by using the embodiment in which at least DBN was contained and present together with an organic substance other than DBN.

### Example 18

About 50 mg of 4,4-dimethyl-DBN was dissolved into 0.5 mL of NMP, and absorbed into cellulose having about 3 μm of mesh diameter, and placed somewhere within a gas line which was flow rate-controllable. When the 2 ppm concentration of a dried nitrogen-based C₅F₈ gas in a gas state was sprayed to the cellulose at about 800 mL/minute of the flow rate, a change in reflectance ratio was observed in the ultraviolet visible absorption wavelength region around 400 nm±100 nm.

As shown above, in one of the methods for observing the optical change, C₅F₈ which is one kind of the fluorides of unsaturated hydrocarbons in a form of gas could be detected by using the embodiment in which at least the substituted derivative of DBN was contained and present together with an organic substance other than the substituted derivative of DBN.

### Example 19

About 60 mg of 4,4-dimethyl-DBN was dissolved into 0.5 mL of NMP, and absorbed into cellulose having about 3 μm of mesh diameter, and placed somewhere within a gas line which was flow rate-controllable. When the 2 ppm concentration of a dried purified air-based C₅F₈ gas in a gas state was sprayed to the cellulose at about 800 mL/minute of the flow rate, a change in reflectance ratio was observed in the ultraviolet visible absorption wavelength region around 400 nm±100 nm.

As shown above, in one of the methods for observing the optical change, C₅F₈ which is one kind of the fluorides of unsaturated hydrocarbons in a form of gas could be detected by using the embodiment in which at least the substituted derivative of DBN was contained and present together with an organic substance other than the substituted derivative of DBN.

### Example 20

About 80 mg of 4-phenyl-DBN was dissolved into 0.5 mL of NMP, and absorbed into cellulose having about 3 μm of mesh diameter, and placed somewhere within a gas line which was flow rate-controllable. When the 2 ppm concentration of a dried nitrogen-based C₅F₈ gas in a gas state was sprayed to the cellulose at about 800 mL/minute of the flow rate, a change in reflectance ratio was observed in the ultraviolet visible absorption wavelength region around 400 nm±100 nm.

As shown above, in one of the methods for observing the optical change, C₅F₈ which is one kind of the fluorides of unsaturated hydrocarbons in a form of gas could be detected by using the embodiment in which at least the substituted derivative of DBN was contained and present together with an organic substance other than the substituted derivative of DBN.

### Example 21

50 mg of a polymer, JANDAJEL-1,3,4,6,7,8-hexahydro-2H-primido[1,2-a]pyrimidine to which 1,3,4,6,7,8-hexahydro-2H-primido[1,2-a]pyrimidine (HPP) is covalently bonded as a side chain of the polymer was dispersed into 1 mL of a THF solution of toluene, the liquid was applied to a glass surface, and the THF was dried in a nitrogen atmosphere. When the 50 ppm concentration of a dried nitrogen-based C₅F₈ gas in a gas state was sprayed to the surface, a change in reflectance ratio was observed in the ultraviolet visible absorption wavelength region around 400 nm±100 nm.

As shown above, in one of the methods for observing the optical change, C₅F₈ which is one kind of the fluorides of unsaturated hydrocarbons in a form of gas could be detected by using the embodiment in which at least the substituted derivative of HPP was contained and present together with an organic substance other than the substituted derivative of HPP.

In addition to this example, the present invention can be applied to any other embodiments using a high processable polymer, cellulose, alumina or glass.

### Example 22

About 60 mg of 3,4,6,7,8,9-hexahydro-2H-pyrido[1,2-a]pyrimidine was absorbed into cellulose having about 3 μm of mesh diameter, and placed somewhere within a gas line which was flow rate-controllable. When the 50 ppm concentration of a dried nitrogen-based C₅F₈ gas in a gas state was sprayed to the cellulose at about 800 mL/minute of the flow rate, a change in reflectance ratio was observed in the ultraviolet visible absorption wavelength region around 400 nm±100 nm.

As shown above, in one of the methods for observing the optical change, C₅F₈ which is one kind of the fluorides of unsaturated hydrocarbons in a form of gas could be detected by using the embodiment in which 3,4,6,7,8,9-hexahydro-2H-pyrido[1,2-a]pyrimidine which is a nitrogen compound having at least two rings at which an amidine backbone is centered was contained and present together with an organic substance other than the nitrogen compound.

### Example 23

A mixture of about 30 mg of 7-imino-3,4,6,7-tetrahydro-2H-pyrimido[2,1-a]isoquinoline and 1 mL of NMP was absorbed into cellulose having about 3 μm of mesh diameter, and placed somewhere within a gas line which was flow rate-controllable. 7-imino-3,4,6,7-tetrahydro-2H-pyrimido[2,1-a]isoquinoline used in this example is a DBN analog which is a three-cyclic compound in which R₃-R₄ in the general formula (I) are substituted with, any generally known hydrocarbon groups, namely, any groups in organic chemistry, such as an imino group and benzene ring having nitrogen which is one of hetero atoms.

When the 50 ppm concentration of a dried nitrogen-based C₅F₈ gas in a gas state was sprayed to the cellulose at about 800 mL/minute of the flow rate, a change in reflectance ratio was observed in the ultraviolet visible absorption wavelength region around 400 nm±100 nm.

As shown above, in one of the methods for observing the optical change, C₅F₈ which is one kind of the fluorides of unsaturated hydrocarbons in a form of gas could be detected by using the embodiment in which 7-imino-3,4,6,7-tetrahydro-2H-pyrimido[2,1-a]isoquinoline which is a nitrogen compound having three rings at which an amidine backbone is centered was contained and present together with an organic substance other than the nitrogen compound.

### Example 24

About 70 mg of 1,3,4,6,7,8-hexahydro-2H-primido[1,2-a]pyrimidine (HPP) was dissolved into 1 mL of NMP, and absorbed into cellulose having about 3 μm of mesh diameter, and placed somewhere within a gas line which was flow rate-controllable. When the 50 ppm concentration of a dried nitrogen-based C₅F₈ gas in a gas state was sprayed to the cellulose at about 800 mL/minute of the flow rate, a change in reflectance ratio was observed in the ultraviolet visible absorption wavelength region around 400 nm±100 nm.

As shown above, in one of the methods for observing the optical change, C₅F₈ which is one kind of the fluorides of unsaturated hydrocarbons in a form of gas could be detected by using the embodiment in which HPP which is a nitrogen compound having at least two rings at which an amidine backbone is centered was contained and present together with an organic substance other than the nitrogen compound.

### Example 25

About 90 mg of tetramisole was dissolved into 1 mL of dimethylformamide DMF, and absorbed into cellulose having about 3 μm of mesh diameter. When a C₅F₈ gas in a gas state was sprayed to the cellulose, a change in reflectance ratio was observed in the ultraviolet visible absorption wavelength region around 400 nm±100 nm.

As shown above, in one of the methods for observing the optical change, C₅F₈ which is one kind of the fluorides of unsaturated hydrocarbons in a form of gas could be detected by using the embodiment in which tetramisole which is a nitrogen compound having at least two rings at which an amidine backbone is centered was contained and present together with an organic substance other than the nitrogen compound.

### Example 26

About 90 mg of 1,3,4,6,7,8-hexahydro-1-methyl-2H-primido[1,2-a]pyrimidine (MeHPP) was absorbed into cellulose having about 3 μm of mesh diameter, and placed somewhere within a gas line which was flow rate-controllable. When the 50 ppm concentration of a dried nitrogen-based C₅F₈ gas in a gas state was sprayed to the cellulose at about 800 mL/minute of the flow rate, a change in reflectance ratio was observed in the ultraviolet visible absorption wavelength region around 400 nm±100 nm.

As shown above, in one of the methods for observing the optical change, C₅F₈ which is one kind of the fluorides of unsaturated hydrocarbons in a form of gas could be detected by using the embodiment in which the substituted derivative of HPP which is a nitrogen compound having at least two rings at which an amidine backbone is centered was contained and present together with an organic substance other than the substituted derivative.

### Example 27

About 30 mg of 1,3,4,6,7,8-hexahydro-1-methyl-2H-primido[1,2-a]pyrimidine (MeHPP) was dissolved into 1 mL of NMP. When the 50 ppm concentration of a dried nitrogen-based C₅F₈ gas in a gas state was bubbled into the solution, a change in reflectance ratio was observed in the ultraviolet visible absorption wavelength region around 400 nm±100 nm, and UV light was observed with 254 nm excitation.

In the detection according to the present invention, C₅F₈ which is one kind of the fluorides of unsaturated hydrocarbons in a form of gas can be detected, without any limitation to kinds of the optical changes, by using any of the methods for detecting the optical changes in any combinations thereof.

### Example 28

About 40 mg of 7-imino-3,4,6,7-tetrahydro-2H-pyrimido[2,1-a]isoquinoline was dissolved into 1 mL of NMP. When the 50 ppm concentration of a dried nitrogen-based C₅F₈ gas in a gas state was bubbled into the solution, a change in reflectance ratio was observed in the ultraviolet visible absorption wavelength region around 400 nm±100 nm, and UV light was observed with 254 nm excitation.

In the detection according to the present invention, C₅F₈ which is one kind of the fluorides of unsaturated hydrocarbons in a form of gas can be detected, without any limitation to kinds of the optical changes, by using any of the methods for detecting the optical changes in any combinations thereof.

### Example 29

A surface of QCM (Quarts Crystal Microbalance: a crystal balance) to which gold was deposited was immersed into an ethanol solution of 6-hydroxyhexanethiol. On the resulting surface, a DBU ethanol solution was casted, and dried in a nitrogen atmosphere. When the membrane surface was set to the QCM apparatus in a chamber and 2 ppm of C₅F₈ gas was introduced thereto, a change of resonance frequency (about 6 MHz in this case) was observed in accordance with the mass change of the membrane surface formed on QCM.

In this example, the resonance frequency change was converted to the mass change and plotted on the ordinate, and time was plotted on the abscissa. The result is shown in broke lines in the graph of FIG. 3.

As can clearly be seen from FIG. 3 (the broken lines), 2 ppm of C₅F₈ which is one kind of the fluorides of unsaturated hydrocarbons in a state of gas could be detected by using the mass change resulting from the reaction with the nitrogen compound having at least two rings at which an amidine backbone is centered.

### Example 30

A surface of QCM (Quarts Crystal Microbalance: a crystal balance) to which gold was deposited was immersed into an ethanol solution of 6-hydroxyhexanethiol. On the resulting surface, a DBU ethanol solution was casted, and dried in a nitrogen atmosphere. When the membrane surface was set to the QCM apparatus in a chamber and 30 ppb of C₅F₈ gas was introduced thereto, a change of resonance frequency (about 6 MHz in this case) was observed in accordance with the mass change of the membrane surface formed on QCM.

In this example, the resonance frequency change was converted to the mass change and plotted on the ordinate, and time was plotted on the abscissa. The result is shown in broke lines in the graph of FIG. 3.

As can clearly be seen from FIG. 3 (the broken lines), 30 ppb of C₅F₈ which is one kind of the fluorides of unsaturated hydrocarbons in a form of gas could be detected by using the mass change resulting from the reaction with the nitrogen compound having at least two rings at which an amidine backbone is centered.

### Example 31

DBN and dichlorohexylmethylamine were mixed at a molar ratio of about 1:1.6. About 2 μL, of the solution was absorbed into cellulose having about 3 μm of mesh diameter. When the 2 ppm concentration of C₅C₈ gas in a gas state was sprayed to the cellulose at 800 mL/minute of the flow rate for one minute, where the gas was a dried air-based gas containing about 20% of (28 million ppm) of excessive FLUORINERT 71, a change in reflectance ratio was observed in the ultraviolet visible absorption wavelength region around 400 nm±100 nm.

As shown above, in one of the methods for observing the optical change, C₅F₈ which is one kind of the fluorides of unsaturated hydrocarbons in a form of gas could be detected at the level of 2 ppm, by using the embodiment in which at least DBN was contained and present together with the cellulose and dichlorohexylmethylamine which are organic substances other than DBN, despite the presence of the hindrance gas, perfluorocarbon.

### Example 32

DBN and dichlorohexylmethylamine were mixed at a molar ratio of about 1:1.6. About 2 μL of the solution was absorbed into cellulose having about 3 μm of mesh diameter. When the 2 ppm concentration of C₅C₈ gas in a gas state was sprayed to the cellulose at 800 mL/minute of the flow rate for one minute, where the gas was a dried air-based gas containing about 26% of excessive NOVECK 7100, a change in reflectance ratio was observed in the ultraviolet visible absorption wavelength region around 400 nm±100 nm.

As shown above, in one of the methods for observing the optical change, C₅F₈ which is one kind of the fluorides of unsaturated hydrocarbons in a form of gas could be detected at the level of 2 ppm, by using the embodiment in which at least DBN was contained and present together with the cellulose and dichlorohexylmethylamine which are organic substances other than DBN, despite the presence of the hindrance gas at the largely excessive amount.

### Example 33

DBN and dichlorohexylmethylamine were mixed at a molar ratio of about 1:1.6. About 2 μL of the solution was absorbed into cellulose having about 3 μm of mesh diameter. When the 2 ppm concentration of C₅C₈ gas in a gas state was sprayed to the cellulose at 800 mL/minute of the flow rate for one minute, where the gas was formed as a dried air-based gas containing about 13 ppm of the excessive concentration of hydrochloric acid gas, a change in reflectance ratio was observed in the ultraviolet visible absorption wavelength region around 400 nm±100 nm. Any similar reflectance ratio change could not be observed with the hydrochloric acid gas alone.

As shown above, in one of the methods for observing the optical change, C₅F₈ which is one kind of the fluorides of unsaturated hydrocarbons in a form of gas could be detected at the level of 2 ppm, by using the embodiment in which at least DBN was contained and present together with the cellulose and dichlorohexylmethylamine which are organic substances other than DBN, despite the presence of the acid gas at the largely excessive amount.

### Example 34

DBN and dichlorohexylmethylamine were mixed at a molar ratio of about 1:1.6. About 2 μL of the solution was absorbed into cellulose having about 3 μm of mesh diameter. When the 2 ppm concentration of C₅C₈ gas in a gas state was sprayed to the cellulose at 800 mL/minute of the flow rate for one minute, where the gas was formed as a dried air-based gas containing about 48 ppm of the excessive concentration of ammonia gas, a change in reflectance ratio was observed in the ultraviolet visible absorption wavelength region around 400 nm±100 nm. Any similar reflectance ratio change could not be observed with the ammonium gas alone.

As shown above, in one of the methods for observing the optical change using the embodiment in which at least DBN was contained and present together with the cellulose and dichlorohexylmethylamine which are organic substances other than DBN, C₅F₈ which is one kind of the fluorides of unsaturated hydrocarbons in a form of gas could be detected at the level of 2 ppm despite the presence of the hindrance gas (an alkaline gas) at the largely excessive amount.

### Example 35

About 60 mg of DBN was mixed with about 100 mg of dichlorohexylmethylamine, and absorbed into cellulose having about 3 μm of mesh diameter, and placed somewhere within a gas line which was flow rate-controllable. When about 50% concentration of a dried air-based 1,1,1,3,3,3-hexafluoropropane (C₃F₅H₂) gas was sprayed to the cellulose at about 900 mL/minute of the flow rate, a change in reflectance ratio was observed in the ultraviolet visible absorption wavelength region around 400 nm±100 nm.

As shown above, by using one of the methods for observing the optical change according to the embodiment in which at least DBN was contained and present together with an organic substance other than DBN, C₅F₈H₂ could be detected, which is fluoride of unsaturated hydrocarbons having at least a hydrogen-carbon moiety in a molecule and having an anionic elimination group bonded to a carbon next to a carbon bonded to the hydrogen-carbon moiety, that is, one kind of HFC (hydrofluorocarbon).

### Example 36

About 60 mg of DBN was mixed with about 100 mg of dichlorohexylmethylamine, and absorbed into cellulose having about 3 μm of mesh diameter, and placed somewhere within a gas line which was flow rate-controllable. When about 50% concentration of a dried air-based 1,1,1,2,2-pentafluoroethane (C₂F₅H) gas was sprayed to the cellulose at about 900 mL/minute of the flow rate, a change in reflectance ratio was observed in the ultraviolet visible absorption wavelength region around 400 nm±100 nm.

As shown above, by using one of the methods for observing the optical change according to the embodiment in which at least DBN was contained and present together with an organic substance other than DBN, C₂F₅H could be detected, which is fluoride of unsaturated hydrocarbons having at least a hydrogen-carbon moiety in a molecule and having an anionic elimination group bonded to a carbon next to a carbon bonded to the hydrogen-carbon moiety, that is, one kind of HFC (hydrofluorocarbon).

### Example 37

About 60 mg of DBN was mixed with about 100 mg of dichlorohexylmethylamine, and absorbed into cellulose having about 3 μm of mesh diameter. When about 40% concentration of β-(n-heptafluoropropyl) propionic acid dissolved into ethanol was dropped onto the cellulose which was heated to about 40° C., a change in reflectance ratio was observed in the ultraviolet visible absorption wavelength region around 400 nm±100 nm.

As shown above, by using one of the methods for observing the optical change according to the embodiment in which at least DBN was contained and present together with an organic substance other than DBN, β-(n-heptafluoopropyl) propionic acid could be detected, which is fluoride of unsaturated hydrocarbons having at least a hydrogen-carbon moiety in a molecule and having an anionic elimination group bonded to a carbon next to a carbon bonded to the hydrogen-carbon moiety and having a carboxyl group whose a general substituent group other than the anionic elimination group was substituted.

### Example 38

About 60 mg of DBN was mixed with about 100 mg of dichlorohexylmethylamine, and absorbed into cellulose having about 3 μm of mesh diameter, and placed somewhere within a gas line which was flow rate-controllable. When about 30% concentration of a dried air-based 1,1-dichloro-2,2,2-trifluoroethane (C₂Cl₂F₃H) gas was sprayed to the cellulose at about 900 mL/minute of the flow rate, a change in reflectance ratio was observed in the ultraviolet visible absorption wavelength region around 400 nm±100 nm.

As shown above, in one of the methods for observing the optical change using the embodiment in which at least DBN was contained and present together with an organic substance other than DBN, C₂Cl₂F₃H could be detected, which is fluoride of unsaturated hydrocarbons having at least a hydrogen-carbon moiety in a molecule and having an anionic elimination group bonded to a carbon next to a carbon bonded to the hydrogen-carbon moiety, that is, one kind of HCFC (hydrochlorofluorocarbon).

### Example 39

About 60 mg of DBN was mixed with about 100 mg of dichlorohexylmethylamine, and absorbed into cellulose having about 3 μm of mesh diameter. When a saturated gas of 1,1,1,4,4,4 hexafluoro-2-butyne was carefully sprayed to the cellulose which was heated to about 40° C., a change in reflectance ratio was observed in the ultraviolet visible absorption wavelength region around 400 nm±100 nm.

As shown above, in one of the methods for observing the optical change using the embodiment in which at least DBN was contained and present together with an organic substance other than DBN, 1,1,1,4,4,4-hexafluoro-2-butyne could be detected, which is one kind of gaseous fluorides of unsaturated hydrocarbons having carbon-carbon triple bonds.

### Example 40

About 60 mg of DBN was mixed with about 100 mg of dichlorohexylmethylamine, and absorbed into cellulose having about 3 μm of mesh diameter. When about 10% concentration of tetrachorethylene dissolved into toluene was dropped onto the cellulose which was heated to about 50° C., a change in reflectance ratio was observed in the ultraviolet visible absorption wavelength region around 400 nm±100 nm.

As shown above, in one of the methods for observing the optical change using the embodiment in which at least DBN was contained and present together with an organic substance other than DBN, tetrachorethylene could be detected, which is liquid unsaturated hydrocarbon having only chlorine as substituent groups, that is, one kind of chlorocarbons categorized in the second class organic solvents.

### Example 41

About 60 mg of DBN was mixed with about 100 mg of dichlorohexylmethylamine, and absorbed into cellulose having about 3 μm of mesh diameter. When a saturated gas of trichlorethylene was sprayed to the cellulose which was heated to about 50° C., a change in reflectance ratio was observed in the ultraviolet visible absorption wavelength region around 400 nm±100 nm.

As shown above, in one of the methods for observing the optical change using the embodiment in which at least DBN was contained and present together with an organic substance other than DBN, the trichlorethylene gas could be detected, which is gaseous unsaturated hydrocarbon having only chlorine as substituent groups, that is, one kind of chlorocarbons.

### Example 42

About 60 mg of DBN was mixed with about 100 mg of dichlorohexylmethylamine, and absorbed into cellulose having about 3 μm of mesh diameter. When about 20% concentration of octachlorocyclopentene dissolved into THF was dropped onto the cellulose which was heated to about 50° C., a change in reflectance ratio was observed in the ultraviolet visible absorption wavelength region around 400 nm±100 nm.

As shown above, in one of the methods for observing the optical change using the embodiment in which at least DBN was contained and present together with an organic substance other than DBN, octachlorocyclopentene could be detected, which is liquid unsaturated hydrocarbon having only chlorine as substituent groups.

### Example 43

About 60 mg of DBN was mixed with about 100 mg of dichlorohexylmethylamine, and absorbed into cellulose having about 3 μm of mesh diameter. When about 10% concentration of 1,1,2,2-tetrachloroethane (C₂Cl₄H₂) dissolved into toluene was dropped onto the cellulose which was heated to about 50° C., a change in reflectance ratio was observed in the ultraviolet visible absorption wavelength region around 400 nm±100 nm.

As shown above, in one of the methods for observing the optical change using the embodiment in which at least DBN was contained and present together with an organic substance other than DBN, C₂Cl₄H₂ could be detected, which is liquid saturated hydrocarbon having two or more carbons which have only chlorine as substituent groups.

### Example 44

About 60 mg of DBN was mixed with about 100 mg of dichlorohexylmethylamine, and absorbed into cellulose having about 3 μm of mesh diameter. When about 10% concentration of 1,2-dibromo-1,2-dichloroethane(C₂Br₂Cl₂H₂) dissolved into toluene was dropped onto the cellulose which was heated to about 50° C., a change in reflectance ratio was observed in the ultraviolet visible absorption wavelength region around 400 nm±100 nm.

As shown above, in one of the methods for observing the optical change using the embodiment in which at least DBN was contained and present together with an organic substance other than DBN, C₂Br₂Cl₂H₂ could be detected, which is liquid saturated hydrocarbon having two or more carbons which have only chlorine and bromine as substituent groups.

### Example 45

About 60 mg of DBN was mixed with about 100 mg of dichlorohexylmethylamine, and absorbed into cellulose having about 3 μm of mesh diameter. When about 10% concentration of 1,2-dibromoethane dissolved into toluene was dropped onto the cellulose which was heated to about 70° C., a change in reflectance ratio was observed in the ultraviolet visible absorption wavelength region around 400 nm±100 nm.

As shown above, in one of the methods for observing the optical change using the embodiment in which at least DBN was contained and present together with an organic substance other than DBN, 1,2-dibromoethane could be detected, which is liquid saturated hydrocarbon having two or more carbons which have only bromine as substituent groups.

### Example 46

About 60 mg of DBN was mixed with about 100 mg of dichlorohexylmethylamine, and absorbed into cellulose having about 3 μm of mesh diameter. When about 10% concentration of 1,2-dibromoethylene dissolved into toluene was dropped onto the cellulose which was heated to about 70° C., a change in reflectance ratio was observed in the ultraviolet visible absorption wavelength region around 400 nm±100 nm.

As shown above, in one of the methods for observing the optical change using the embodiment in which at least DBN was contained and present together with an organic substance other than DBN, 1,2-dibromoethylene could be detected, which is liquid unsaturated hydrocarbon having two or more carbons which have only bromine as substituent groups.

### Example 47

About 60 mg of DBN was mixed with about 100 mg of dichlorohexylmethylamine, and absorbed into cellulose having about 3 μm of mesh diameter. When a saturated gas of 1,2-dibromoethylene in the air was sprayed to the cellulose which was heated to about 70° C., a change in reflectance ratio was observed in the ultraviolet visible absorption wavelength region around 400 nm±100 nm.

As shown above, in one of the methods for observing the optical change using the embodiment in which at least DBN was contained and present together with an organic substance other than DBN, the 1,2-dibromoethylene gas could be detected, which is gaseous unsaturated hydrocarbon having only bromine as substituent groups.

### Example 48

About 60 mg of DBN was mixed with about 100 mg of dichlorohexylmethylamine, and absorbed into cellulose having about 3 μm of mesh diameter. When about 20% concentration of 1,2-dibromocyclo-1-pentene dissolved into toluene was dropped onto the cellulose which was heated to about 70° C., a change in reflectance ratio was observed in the ultraviolet visible absorption wavelength region around 400 nm±100 nm.

As shown above, in one of the methods for observing the optical change using the embodiment in which at least DBN was contained and present together with an organic substance other than DBN, 1,2-dibromocyclo-1-pentene could be detected, which is liquid unsaturated hydrocarbon having two or more carbons which have only bromine as substituent groups.

### Example 49

About 40 mg of DBN was mixed with about 60 mg of 1-methyl-3-n-octylimidazoliumbromide dried with molecular sieve 4A, and absorbed into cellulose having about 3 μm of mesh diameter, and placed somewhere in a gas line which was flow rate-controllable. The mixing ratio can be any other figures, and may not limited to those in this exampled. When the 2 ppm concentration of an indoor air-based C₅F₈ gas was sprayed to the cellulose at about 800 mL/minute of the flow rate, a change in reflectance ratio was observed in the ultraviolet visible absorption wavelength region around 400 nm±100 nm.

As shown above, in one of the methods for observing the optical change using the embodiment in which at least DBN was contained and present together with an organic substance other than DBN, that is, the embodiment in which the ionic liquid coexists, C₅F₈ could be detected, which is one kind of gaseous fluorides of unsaturated hydrocarbons, by using.

1. A detection agent comprising as an active component a nitrogen compound having at least two rings at which an amidine backbone is centered which is represented by the general formula (I) described below, wherein the detection agent detects any of halides selected from (1) fluorides of unsaturated hydrocarbons, (2) fluorides of hydrocarbons having at least a hydrogen-carbon moiety in a molecule and having an anionic elimination group bonded to a carbon next to a carbon bonded to the hydrogen-carbon moiety, (3) unsaturated hydrocarbons having only choline and/or bromine as a substituent group, and (4) saturated hydrocarbons having two or more carbons which have only chlorine and/or bromine as a substituent group: 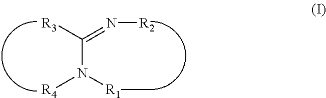
in the formula, each of R₁, R₂, R₃ and R₄ represents a methylene group (CH₂) which may be substituted with other hetero atoms, or a hetero atom of a nitrogen atom (N), an oxygen atom (O) or an sulfur atom (S) each of which may have a substituent group; a substituent group formed of a hydrocarbon group or a polymer having the hydrocarbon group may be present or introduced between R₃ and R₄; and these groups may form an additional ring portion, thereby forming three or more of rings in the compound.

2. The detection agent according to claim 1, wherein said (1) fluorides of unsaturated hydrocarbons or said (2) fluorides of hydrocarbons having at least a hydrogen-carbon moiety in a molecule and having an anionic elimination group bonded to a carbon next to a carbon bonded to the hydrogen-carbon moiety are in a form of gas.

3. The detection agent according to claim 1, wherein the nitrogen compound having at least two rings at which an amidine backbone is centered represented by the general formula (I) is 1,5-diazabicyclo[4,3,0]non-5-ene (DBN) and/or substituted derivatives thereof.

4. The detection agent according to claim 1, wherein the nitrogen compound having at least two rings at which an amidine backbone is centered represented by the general formula (I) is 1,8-diazabicyclo[5,4,0]undec-7-ene (DBU) and/or substituted derivatives thereof.

5. The detection agent according to claim 1, wherein the nitrogen compound having at least two rings at which an amidine backbone is centered represented by the general formula (I) is 1,3,4,6,7,8-hexahydro-2H-primido[1,2-a]pyrimidine (HPP) (another name is 1,5,7-triazabicyclo[4,4,0]dec-5-en) and/or substituted derivatives thereof.

6. The detection agent according to claim 1, wherein the nitrogen compound having at least two rings at which an amidine backbone is centered represented by the general formula (I) is tetramisole (another name is Levamisole).

7. A method for detecting a halide by using a detection agent which is described in claim 1, the method comprising detecting the halide by using a reaction of the detection agent with the any of the halides selected from (1) fluorides of unsaturated hydrocarbons, (2) fluorides of hydrocarbons having at least a hydrogen-carbon moiety in a molecule and having an anionic elimination group bonded to a carbon next to a carbon bonded to the hydrogen-carbon moiety, (3) unsaturated hydrocarbons having only choline and/or bromine as a substituent group, and (4) saturated hydrocarbons having two or more carbons which have only chlorine and/or bromine as a substituent group.

8. The method according to claim 1, wherein said (1) fluorides of unsaturated hydrocarbons or said (2) fluorides of hydrocarbons having at least a hydrogen-carbon moiety in a molecule and having an anionic elimination group bonded to a carbon next to a carbon bonded to the hydrogen-carbon moiety is in a form of gas.

9. The method according to claim 7, wherein the method comprises performing the reaction under conditions under which an organic substance other than the detection agent coexists.

10. The method according to claim 7, wherein the method comprises detecting an optical change by the reaction.

11. The method according to claim 10, wherein the method comprises detecting one or more of the optical changes selected from changes in absorbance, reflectance ratio, infrared vibration, emission, phosphorescence, refractive index, liquid crystal state, and photoelectron kinetic energy by X-rays.

12. The method according to claim 10, wherein the method comprises detecting 50 ppm or less of the halide by using the change in absorbance or the change in the reflectance ratio in a ultraviolet visible light region.

13. The method according to claim 10, wherein the method comprises detecting ppm or less of the halide by using the change in absorbance or the change in reflectance ratio in a ultraviolet visible light region.

14. The method according to claim 7, wherein the method comprises detecting a mass change by the reaction.

15. The method according to claim 14, wherein the method comprises at least absorbing the detection agent on a vibrating member surface or a QCM substrate and capturing the mass change by the reaction of the halide and the membrane surface as a frequency change of the vibrating member surface or a resonance frequency change of the QCM substrate.

16. The method according to claim 7, wherein said (1) fluorides of unsaturated hydrocarbons are C₅F₈, C₄F₆, or a mixture thereof.

17. The method according to claim 16, wherein said C₅F₈ is octafluorocyclopentene.

18. The method according to claim 16, wherein said C₄F₆ is hexafluorobutadiene, hexafluorocyclobutene, or a mixture thereof.

19. The method according to claim 7, wherein said (2) fluorides of hydrocarbons having at least a hydrogen-carbon moiety in a molecule and having an anionic elimination group bonded to a carbon next to a carbon bonded to the hydrogen-carbon moiety are C₅F₈H₂.

20. The method according to claim 19, wherein said C₅F₈H₂ is octafluorocyclopentane.

21. The method according to claim 19, wherein said C₅F₈H₂ is 1H,2H-octafluorocyclopentane, 1H,1H-octafluorocyclopentane, 1H,3H-octafluorocyclopentane, or a mixture thereof.

22. A detection sensor for detecting a halide, comprising a detector which employs a detection agent described in claim 1, wherein the sensor detects any of halides selected from (1) fluorides of unsaturated hydrocarbons, (2) fluorides of hydrocarbons having at least a hydrogen-carbon moiety in a molecule and having an anionic elimination group bonded to a carbon next to a carbon bonded to the hydrogen-carbon moiety, (3) unsaturated hydrocarbons having only choline and/or bromine as a substituent group, and (4) saturated hydrocarbons having two or more carbons which have only chlorine and/or bromine as a substituent group.

23. The detection sensor according to claim 22, wherein the detection agent is absorbed into a porous material.

24. The detection sensor according to claim 23, wherein the porous material is a meshed cellulose, polymer or porous alumina.

25. The detection sensor according to claim 22, wherein the sensor employs a polymer containing the detection agent.
